(19) United States
(12) Patent Application Publication
(10) Pub. No.: US 2003/0007192 A1
(43) Pub. Date: Jan. 9, 2003

(54) Two-step predetermined text/image identificataion process and system

(76) Inventor: Tatsuya Kuranaga, Yokohama Kanagawa (JP)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 10/177,695

(22) Filed: Jun. 21, 2002

(30) Foreign Application Priority Data
Jun. 22, 2001 (JP) 2001-189644

(51) Int. Cl. H04N 1/40

(52) U.S. Cl. 358/462

(57) ABSTRACT

To avoid illegal duplication of certain documents such as checks, stock certificate and currency notes, predetermined text and or images are identified before a scanned image is duplicated. To identify the predetermined text and images, a first identification process generates a first identification result. Based upon the first identification result, a second identification determines a final identification result. The two-step identification process substantially reduces a rate for generating false results and increases flexibility in the identification criteria.

### FIELD OF THE INVENTION

The current invention is generally related to text and image identification, and more particularly related to a two-step process and system for identifying predetermined text and or image in scanned image data.

### BACKGROUND OF THE INVENTION

In the prior art, an image forming apparatus is used in a device such as a copier. A recent image forming apparatus such as a digital multi function machine includes functions such as facsimile, printing and filing in addition to copying. In order to implement the above functions, the digital multi function machine further includes a large memory device such as a hard disk. The large-capacity memory device stores scanned data and received fax data, and the stored text data is later outputted. The fax data may be further transmitted to another location, and the fax data may be viewed via an external host unit such as a personal computer and a work station.

As color image quality increases in a full color image processing device such as a full color copier, a risk increases for counterfeiting or illegal copying of currency notes and stock certificates. The above material for the prescribed act is hereinafter called predetermined text in the current application. In order to prevent the illegal acts, a full color copier includes a counterfeit prevention unit for identifying the predetermined text in the image data that has been scanned. One prior art relevant technology is Japanese Patent Publication Hei 6-251128, which discloses a method of identifying the predetermined text. The disclosed method performs the identification of the predetermined text based upon certain edge extraction and pattern matching in the image data that has been generated by lowering its resolution level.

In the above described prior art technology, it is virtually impossible for the counterfeit prevention unit to have perfectly accurate identification of the predetermined.

The less than perfect identification is due to variable reading values in a scanner as well as variance in print. In order to improve the identification rate, one way is to lower a threshold value for the identification. However, with the lowered threshold, text may be mistakenly recognized as the predetermined text, and the erroneously identified text data is blocked from being outputted. Another way to improve the identification is to make the identification unit more precise. The more precise hardware in the counterfeit prevention unit prohibitively adds an extra cost to the total cost of the device. The above described difficulties remain to be improved.

### SUMMARY OF THE INVENTION

In order to solve the above and other problems, according to a first aspect of the current invention, an image forming apparatus, including: an image scanner for scanning image data; a data storage unit connected to the image scanner for storing the image data; a first recognition unit connected to the image scanner for determining whether or not the image data contains a predetermined set of data at a first precision level while the image data is being generated, the first recognition unit generating a first recognition result signal; a second recognition unit connected to the first recognition unit for further determining whether or not the image data contains the predetermined set of the data at a second precision level that is higher than the first precision level, the second recognition unit generating a second recognition result signal; and a control unit connected to the data storage unit, the first recognition unit and the second recognition unit for controlling access to the image data in the data storage unit based upon the first recognition result signal and the second recognition result signal.

According to a second aspect of the current invention, a method of discriminating a predetermined set of unauthorized data, including: scanning image data; storing the image data; determining whether or not the image data contains a predetermined set of unauthorized data at a first precision level while the image data is being generated, the first recognition unit generating a first recognition result signal; further determining whether or not the image data contains the predetermined set of the unauthorized data at a second precision level that is higher than the first precision level, the second recognition unit generating a second recognition result signal; and controlling access to the image data in the data storage unit based upon the first recognition result signal and the second recognition result signal.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram illustrating one preferred embodiment of the multi functional digital color copier according to the current invention.

FIG. 2 is a block diagram illustrating one preferred embodiment of the identification process unit according to the current invention.

FIG. 3 is a flow chart illustrating the steps involved in one preferred process of controlling access to the predetermined text according to the current invention.

FIG. 4 is a state diagram illustrating states involved in one preferred process of controlling access to the predetermined text according to the current invention.

### DETAILED DESCRIPTION OF THE PREFERRED EMBODIMENT(S)

Based upon incorporation by external reference, the current application incorporates all disclosures in the corresponding foreign priority document (Japanese Patent 2001-189644) from which the current application claims priority.

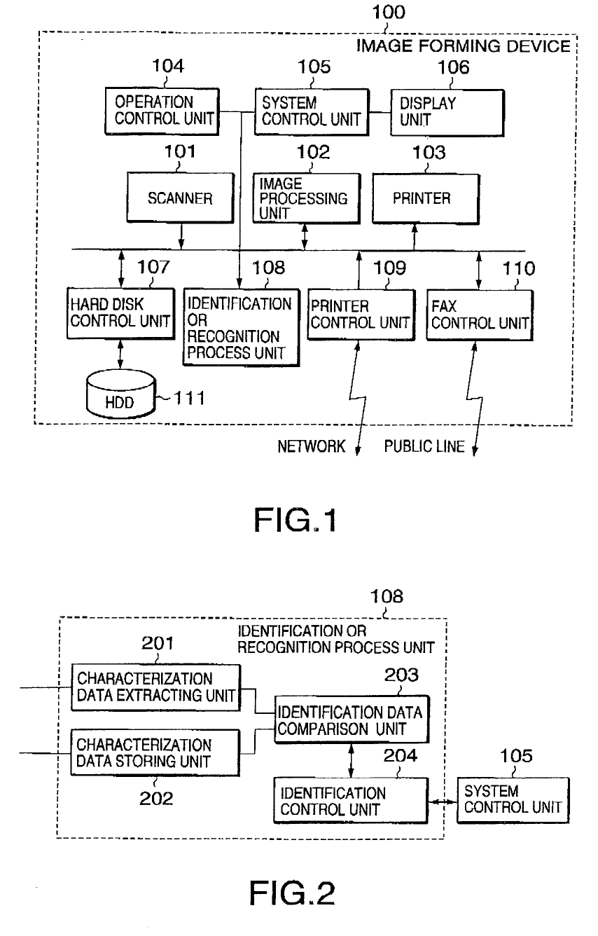

Referring now to the drawings, wherein like reference numerals designate corresponding structures throughout the views, and referring in particular to FIG. 1, a block diagram illustrates one preferred embodiment of the multi functional digital color copier according to the current invention. The digital color copier 100 includes a scanner 101, an image processing unit 102, a printer 103, an operational control unit 104, a system control unit 105, a display unit 106, a hard disk control unit 107, a recognition or identification process unit 108, a printer control unit 109, a fax control unit 110 and a hard disk drive 111. The scanner 101 scans an original image and converts the image into digital data for outputting red-green-blue (RGB) data. The image processing unit 102 performs filtering and color correction on the RGB data from the scanner 101. The image processing unit 102 converts the process data into cyan-magenta-yellow-black (CMYK) data and outputs the CMYK data to the printer 103.

Still referring to FIG. 1, the above enumerated units are further described.

The printer 103 forms an image based upon output data from the image processing unit 102, the printer control unit 109 and the fax control unit 110 and the hard disk drive 111. The operational control unit 104 is an input device for an operator to select a copy mode and to specify a number of duplication and further includes various keys and a touch panel on a display. The display unit 106 is a display device for indicating the operational condition and providing instructions to an operator. The system control unit 105 is connected to other units in the digital color copier 100. Although FIG. 1 fails to illustrate, the system control unit 105 further includes a central processing unit (CPU) for executing computer instructions, a read only memory (ROM) for storing software programs, a random access memory (RAM) as a work area for executing the computer programs and a non-volatile random access memory (NVRAM) for storing certain values that are unique to a device. In general, the software programs in the ROM controls the operation of the various units in the digital color copier 100.

Other units are also described with respect to FIG. 1. The hard disk control unit 107 is an interface with a hard disk unit for recording image signals from each of the units and outputting image data to the printer 103 and the identification or recognition process unit 108. The recognition or identification process unit 108 determines whether or not the predetermined text is included in the RGB signal data from the scanner 101. The identification process unit 108 transfers the above determination result to the system control unit 105. The printer control unit 109 is a printer controller for generating an image. The printer control unit 109 includes a network interface and an output processing for processing page description language (PDL) data from a host machine such as a personal computer and a workstation that is connected to a network and a page memory. The fax control unit 110 is connected to a public line. The fax control unit 110 performs a fax transmission process for transmitting the data from the scanner 101 and the hard disk 111 as well as a fax reception process for receiving data from an external device. The received data or text is stored in the HDD 111 via the hard disk control unit 107. The HDD 111 also stores the scanned image data, the fax reception data and the printer output data.

Now referring to FIG. 2, a block diagram illustrates one preferred embodiment of the identification process unit 108 according to the current invention. The identification process unit 108 receives RGB input data from the scanner 101 or image data that has been stored in the HDD 111. The identification process unit 108 further includes a characterization data extracting unit 201, a characterization data storing unit 202, a characterization data comparing unit 203 and an identification control unit 204. The identification process unit 108 is connected to the system control unit 105. The characterization data extracting unit 201 extracts characterization data from the input image data. The characterization data storing unit 202 stores dictionary data of the characterization data for the predetermined text. The characterization data comparing unit 203 compares the extracted characterization data to the dictionary data of the characterization data for the predetermined text in the characterization data storing unit 202. The characterization data comparing unit 203 generates the above comparison data and outputs it to the identification control unit 204. The identification control unit 204 coordinates the overall control of the identification process unit 108. The above overall control includes initializing parameter values in various units and outputting the comparison results from the data comparing unit 203 to an IPU control unit.

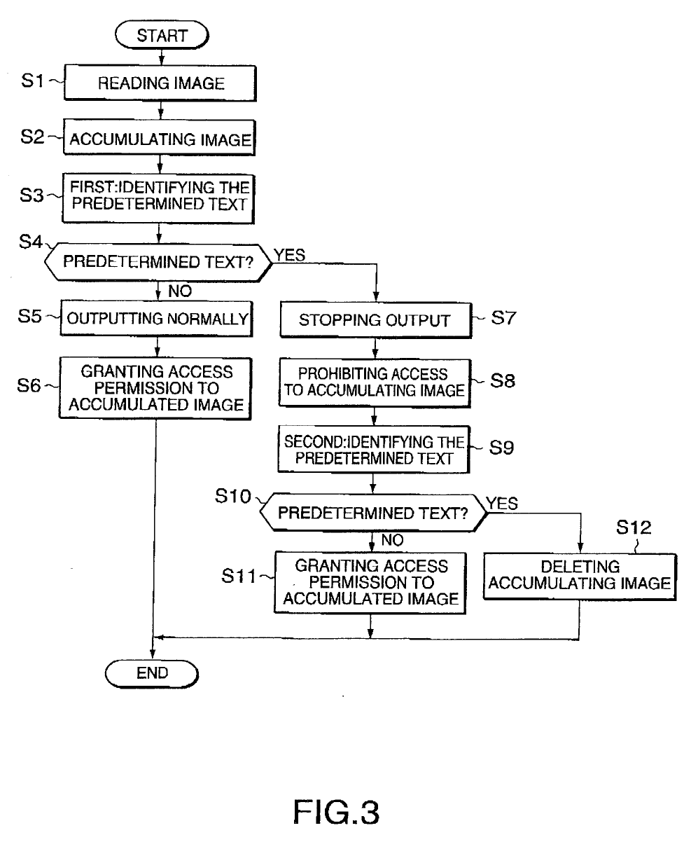

Now referring to FIG. 3, a flow chart illustrates the steps involved in one preferred process of controlling access to the predetermined text according to the current invention. In a step S1, an image is scanned into digital data by the scanner 101. The scanned image is stored in the HDD 111 in a step S2. In a step S3, the identification process unit 108 performs a predetermined identification process on the scanned image data. Based upon the result from the step S3, it is determined whether or not the predetermined text exists in the image data. If it is determined that the scanned image contains no predetermined text in the step S4, an output is normally generated in a step S5. Subsequently or alternatively, the system is given a permission to access the stored scanned in a step S6. On the other hand, if it is determined that the scanned image contains the predetermined text in the step S4, the output is blocked in a step S7 and the access is denied to the scanned image in a step S8. Furthermore, a second identification step is performed in a step S9. In the second identification step in the step S9, the CPU in the system control unit 105 executes a predetermined program containing a certain algorithm for determining the existence of the predetermined text in a more precisely and detailed manner than the identification process unit 108 in the step S3. The algorithm and the predetermined text data are stored in the ROM in the system control unit 105. Two examples of the above described algorithms to work on the stored image are disclosed in Japanese Patent Publications Hei 11-288461 and 11-296683. If it is determined in the step S10 that the predetermined text does not exist in the scanned image data, access permission is granted in a step S11. The granted access permission enable enables the operational unit 104 to output the stored image. On the other hand, if it is determined in the step S10 that the predetermined text does not exist in the scanned image data, the scanned image or the stored image is deleted in a step S12. The preferred process is thus terminated.

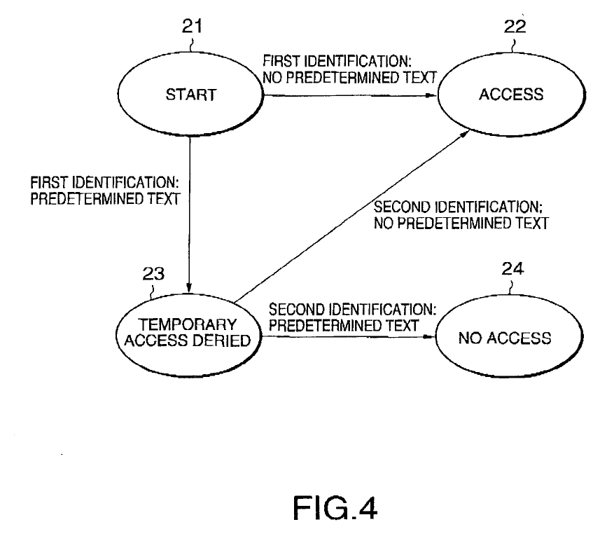

Now referring to FIG. 4, a state diagram illustrates states involved in one preferred process of controlling access to the predetermined text according to the current invention. When the first identification result from the identification process unit 108 is available, an initial state is a start state 21. When the first identification result indicates that the image data contains at least one of the predetermined set of text, the state is now in an access granted state 22. The first identification result also means that the current scanned image exists in a list of permissible images to be duplicated. In the access granted state 22, since the image contains no predetermined text, the scanned image is accessible from an external unit for outputting or displaying. When the first identification result indicates that the image data contains no predetermined text, the state is now in a temporarily denied access state 23. The first identification result also means that the current scanned image does not yet exist in the list of permissible images to be duplicated. In the temporarily denied access state 23, the predetermined text has been detected. Although it is not allowed to output or display the scanned image, the scanned image is still internally stored. In the temporarily denied access state 23, if a result from the second identification process by predetermined software indicates that the scanned image contains no predetermined text, the current state moves to the above access granted state 22. The currently scanned image is now placed in the list of permissible images to be duplicated. In the access granted state 22, the scanned image becomes accessible from an external unit for outputting or displaying. On the other hand, in the temporarily denied access state 23, if a result from the second identification process indicates that the scanned image contains the predetermined text, the current state moves to a no access state 24. In the no access state 24, the scanned image is purged or deleted from the memory and all the associated data is also deleted from the system.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. An image forming apparatus, comprising:
an image scanner for scanning image data;
a data storage unit connected to said image scanner for storing the image data;
a first recognition unit connected to said image scanner for determining whether or not the image data contains a predetermined set of data at a first precision level while the image data is being generated, said first recognition unit generating a first recognition result signal;
a second recognition unit connected to said first recognition unit for further determining whether or not the image data contains the predetermined set of the data at a second precision level that is higher than the first precision level, said second recognition unit generating a second recognition result signal; and
a control unit connected to said data storage unit, said first recognition unit and said second recognition unit for controlling access to the image data in said data storage unit based upon the first recognition result signal and the second recognition result signal.

2. The image forming apparatus according to claim 1 wherein said control unit temporarily prohibits the access to the image data based upon the first recognition result signal indicating that the image data contains the predetermined set of the data while said control unit allows the access to the image data based upon the second recognition result signal indicating that the image data fails to contain the predetermined set of the data.

3. The image forming apparatus according to claim 1 wherein said control unit deletes the image data from said data storage unit based upon the first recognition result signal indicating that the image data contains the predetermined set of the data.

4. The image forming apparatus according to claim 1 wherein said control unit deletes the image data from said data storage unit based upon the second recognition result signal indicating that the image data contains the predetermined set of the data.

5. The image forming apparatus according to any one of claims 1, 2 and 4 wherein said control unit executes a predetermined computer program to perform tasks as executed by said second recognition unit.

6. The image forming apparatus according to claim 1 wherein the predetermined set of the data includes text which should not be duplicated without proper authority.

7. The image forming apparatus according to claim 1 wherein the predetermined set of the data includes image which should not be duplicated without proper authority.

8. The image forming apparatus according to claim 1 wherein the first precision level and the second precision level are independently determined.

9. The image forming apparatus according to claim 1 further including a fax machine connected to said data storage unit and said control unit for transmitting the image data.

10. The image forming apparatus according to claim 1 further including a printer connected to said data storage unit and said control unit for printing the image data.

11. A method of discriminating a predetermined set of unauthorized data, comprising:
scanning image data;
storing the image data;
determining whether or not the image data contains a predetermined set of unauthorized data at a first precision level while the image data is being generated, said first recognition unit generating a first recognition result signal;
further determining whether or not the image data contains the predetermined set of the unauthorized data at a second precision level that is higher than the first precision level, said second recognition unit generating a second recognition result signal; and
controlling access to the image data in said data storage unit based upon the first recognition result signal and the second recognition result signal.

12. The method of discriminating a predetermined set of unauthorized data according to claim 11 wherein said controlling step prohibits the access to the image data based upon the first recognition result signal indicating that the image data contains the predetermined set of the unauthorized data while said control unit allows the access to the image data based upon the second recognition result signal indicating that the image data fails to contain the predetermined set of the unauthorized data.

13. The method of discriminating a predetermined set of unauthorized data according to claim 11 wherein said controlling step deletes the image data based upon the first recognition result signal indicating that the image data contains the predetermined set of the unauthorized data.

14. The method of discriminating a predetermined set of unauthorized data according to claim 11 wherein said controlling step deletes the image data based upon the second recognition result signal indicating that the image data contains the predetermined set of the unauthorized data.

15. The method of discriminating a predetermined set of unauthorized data according to any one of claims 11, 12 and 14 wherein said controlling step executes a predetermined computer program.

16. The method of discriminating a predetermined set of unauthorized data according to claim 11 wherein the predetermined set of the unauthorized data includes text which should not be duplicated without proper authority.

17. The method of discriminating a predetermined set of unauthorized data according to claim 11 wherein the predetermined set of the unauthorized data includes image which should not be duplicated without proper authority.

18. The method of discriminating a predetermined set of unauthorized data according to claim 11 wherein the first precision level and the second precision level are independently determined.

19. The method of discriminating a predetermined set of unauthorized data according to claim 11 further comprising an additional step of transmitting the image data via a fax machine.

20. The method of discriminating a predetermined set of unauthorized data according to claim 11 further comprising an additional step of printing the image data.
